(19) United States
(12) Patent Application Publication
(10) Pub. No.: US 2011/0107599 A1
(43) Pub. Date: May 12, 2011

(54) Method for manufacturing wheels

(75) Inventor: Takeshi Tanaka, Osaka (JP)

(73) Assignee: WORK CO., LTD., Higashiosaka-shi (JP)

(21) Appl. No.: 12/929,300

(22) Filed: Jan. 13, 2011

Related U.S. Application Data
(62) Division of application No. 11/512,329, filed on Aug. 30, 2006.

(30) Foreign Application Priority Data
Sep. 1, 2005 (JP) 2005-253019
Jun. 5, 2006 (JP) 2006-155696

(51) Int. Cl. B23P 17/00

(52) U.S. Cl. 29/894.322

(57) ABSTRACT

To provide a manufacturing method of wheels which can easily and beautifully remove plating at the welding planned portion and which can manufacture wheels with rims plated at low price and efficiently.

A method for manufacturing two-piece type wheels having a rim 2 and a disk, in which after providing a chromium plating to the rim 2 as a wheel component member, a welding planned portion RW with respect to the disk on the inner circumferential surface of the rim is ground by a grinding belt 29, removing plating at the welding planned portion RW, thereafter the disk is fitted and fixed to the rim 2 so that the disk and the rim are welded and joined along the welding planned portion RW.

### BACKGROUND OF THE INVENTION

1. Technical Field

The present invention relates to a method for manufacturing wheels.

2. Background Art

As wheels for vehicles made of aluminum alloys and other light alloys, widely practiced wheels include one-piece wheels integrally formed by welding, two-piece wheels configured by dividing the wheel into two parts that are a rim and a disk, and three-piece wheels configured by dividing the wheel into three parts that are an inner rim, an outer rim, and a disk.

As a manufacturing method of two-piece wheels, there is a widely adopted manufacturing method in which a cylindrical rim is heated to fit a disk in the inside of which a disk is fitted, and in a state that the disk is fitted and fixed to a suitable place in the axial direction of the rim by shrinkage-fitting, an outer circumferential surface of the disk is welded to an inner circumferential surface of the rim in order to integrate the disk and the rim into one.

As a manufacturing method of three-piece wheels, there is a widely adopted manufacturing method in which an annular superimposed part extending inwards in the radial direction is formed on one end part of each of the inner rim and the outer rim respectively, superimposing the superimposed parts to assemble both of the rims concentrically, superimposing the superimposed part to an outer circumferential part of the disk under the above state, tightening these three parts by bolts, after which welding is provided from the outer circumferential side along the superimposed portion of the inner rim and the outer rim, so that both of the rims are airtightly integrated into one.

On the other hand, a wheel subjected to a plating treatment such as chromium plating to enhance design features is proposed and put into practical use. In one-piece wheels, a whole wheel is immersed into plating liquid to carry out a plating treatment (for example, refer to Japanese Unexamined Patent Publication No. Hei 11-236681). However, in two-piece wheels and three-piece wheels, presence of plating at a welding planned portion of each of the wheel component members generates welding defects, and the following plating treatment is therefore implemented.

That is, in two-piece wheels, a welding planned portion is formed in at a halfway of an inner circumferential surface of a rim in the axial direction, causing it extremely troublesome to remove plating of the welding planned portion. Therefore, a wheel is generally configured to to provide a plating treatment only for a disk, not for a rim. Consequently, it is possible to fabricate a two-piece wheel in which a plating treatment is provided for a rim, but a plating treatment is not provided for a rim of a widely used wheel due to an increased manufacturing cost.

In addition, in three-piece wheels, in order to increase design features, a plating treatment is provided for a disk and an outer rim, while for the inner rim having little effects on design features, an alumite treatment is provided in place of the plating treatment to reduce a manufacturing cost. Also, in order to prevent welding defects of rims caused by plating or oxide coating, with respect to the outer rim, the outer rim is immersed in plating liquid to carry out plating treatment in a state of, for example, providing masking for a welding planned portion, or plating of the welding planned portion of the outer rim which have been subjected to a plating treatment is removed manually by the use of a portable grinder or the like, or plating of the welding planned portion of the outer rim is removed by cutting in a machine process, and with respect to the inner rim, oxide film of the welding planned portion is removed manually by the use of, for example, a wire brush or the like.

### SUMMARY OF THE INVENTION

In two-piece wheels, there is no two-piece wheel having a plated rim that are widely used and in three-piece wheels, there are following problems when plating of a welding planned portion of an outer rim is removed.

That is, in the event that a welding planned portion of an outer rim is provided with masking to carry out a plating treatment, there are problems that a troublesome operation of affixing masking tape is required. In addition, since plating treatment requires special technique and it is not generally carried out by a wheel manufacturer but by a manufacturer specialized in a plating treatment, there is a problem of increasing a labor cost for a plating treatment for an operation of affixing a masking tape and increasing the a wheel manufacturing cost.

Since delicate irregularities are formed on an outer surface of the outer rim, even if the masking tape is neatly affixed, the plating liquid may invade between the masking tape and the rim when the rim is immersed in plating liquid and part of the welding planned portion may be plated, which is made to be one of the causes in welding defects of the plating part in the welding planned portion. Furthermore, in the event that chromium plating is provided as a plating treatment, a rim is successively immersed in a plurality of treatment liquid, the plating liquid that invaded between a masking tape and the rim is brought into the other treatment liquid in the subsequent processes, creating a problem of contaminating treatment solutions in the subsequent processes. Still more, an adhesive component of a masking tape is dissolved into treatment liquid, resulting in a problem of degrading treatment liquid.

Furthermore, in the case of masking, as shown in FIG. 15, there is a problem that, at the boundary part 103 between a base material area 101 formed on a welding planned portion of a rim 100 by affixing a masking tape and a plated area 102 other than the base material area 101, an elevated part 104 is formed along a side edge of a masking tape on the plated area 102, and a level difference is formed at the boundary 103 between the base material area 101 and the plated area 102, causing easy exfoliation of plating by a physical shock, and a formation of an incomplete plated area 105 such as, for example, a copper plating layer as a substrate layer in the case of chromium plating, by plating liquid invaded between the masking tape and the rim, and resulting in easy exfoliation of the plated area 102 from the relevant portion 105.

On the other hand, in the event that plating of a welding planned portion is removed by cutting or the like in a machine process, plating of the welding planned portion can be neatly removed and an operation of affixing masking tape is not required, besides affixing a masking tape is not necessary, thereby a labor cost of plating treatment is minimized, the manufacturing cost of a wheel can be reduced. However, cutting a plated area by a single cutting treatment causes a force exerted to the plated area in the direction to exfoliate plating when a cutting tool is withdrawn from the plated area, resulting in a problem of easy exfoliation of the plated area from the boundary with a base material portion. In addition, in order to prevent the above stated problem, it is assumed to insert a cutting tool from both side edges of welding planned portion and to allow the cutting tool to withdraw at halfway in the width direction of the welding planned portion. However, it is required to implement a cutting treatment twice, resulting in a problem of extremely troublesome operation. Furthermore, in the event removing plating of an outer circumferential face of a curved part linked from a superimposed portion of rims to a cylindrical body part as is the case of a three-piece wheel, a cutting tool must be moved along the curved surface of the curved part which is different in a curvature among different types of wheels, resulting in a problem that control of the cutting tool is made extremely complicated.

In addition, in a method to remove plating of the welding planned portion by a manual operation using a portable grinder or the like, processing carried out from an outer circumference side of an outer rim enables removal of plating with a comparative easiness even at a curved welding planned portion, but there are problems of requiring workforce and generating variations in dimensional accuracies and surface properties of a grinding surface.

It is an object of the present invention to provide a manufacturing method of wheels which can easily and neatly remove plating of a welding planned portion and manufacture wheels with rims efficiently plated at low cost.

A first manufacturing method of wheels related to the present invention includes steps of providing a chromium plating treatment to wheel component members, grinding a welding planned portion of the wheel component members by an abrasive cloth/paper, removing plating of the welding planned portion, and welding and joining the wheel component members along the welding planned portion.

A second manufacturing method of wheels related to the present invention is a manufacturing method of two-piece type wheels composed of a rim and ad disk, in which after providing a chromium plating treatment to a rim as a wheel component member, a welding planned portion with a disk on an inner circumferential surface of the rim is ground by an abrasive cloth/paper, removing plating of the welding planned portion, after which the disk is fixed into the rim, so that the disk and the rim are welded and joined along the welding planned portion.

In this second manufacturing method of wheels, a preferable embodiment includes steps such as using a grinding belt in which one end of the abrasive cloth/paper is stretched over a pulley capable of being inserted in the wheel and rotatable around a center axis thereof substantially parallel to a center axis of the wheel and the other end of the abrasive cloth/paper is stretched over a pulley rotatable around a vertical center axis thereof arranged outside of the wheel, and grinding with the abrasive cloth/paper pressed and brought in contact with the inner circumferential surface on a bottom of the rim under a condition that the rim is set with a center axis thereof made substantially in parallel to the support roller onto two parallel support rollers with center axes thereof made substantially horizontal at the grinding of inner circumferential of the rim.

A third manufacturing method of wheels related to the present invention is a manufacturing method of three-piece type wheels composed of an inner rim, an outer rim, and a disk, in which a chromium plating treatment is first provided for the outer rim as a wheel component member, then grinding a welding planned portion on an outer circumferential surface of the curved part linked from a superimposed part of rims to cylindrical body part in the outer rim using an abrasive cloth/paper, removing plating of the welding planned portion, superimposing a superimposed part to assemble both of the rims, superimposing an outer circumferential part of the disk to the superimposed part, after which the disk is fixed to the superimposed part by bolts, so that the welding planned portions of both of the rims are welded and joined from an outside. However, in the event that an alumite treatment is provided for the inner rim, in a state that oxide film of the welding planned portion of the inner rim is removed by a wire brush or the like, the superimposed parts are superimposed to assemble both of the rims.

In the third wheel manufacturing method, a configuration of a preferable embodiment is to use a flap wheel with an abrasive cloth arranged radially as the abrasive cloth/paper to grind the welding planned portion by pressing and bringing the flap wheel substantially vertically in contact with a center part of the welding planned portion.

According to the first manufacturing method of wheels related to the present invention, because a welding planned portion is ground by an abrasive cloth/paper, it is made possible to neatly and accurately remove chromium plating or the like that is hard. In addition, as compared to the cases of masking or cutting, it is possible to prevent a level difference at a boundary between a welding planned portion from which plating was removed and the plated area from being angular, and exfoliation of plating from the boundary can be effectively prevented. Also, as compared to the case of masking, an operation of affixing a masking tape is not required, thereby labor cost for a plating treatment can be minimized and a wheel manufacturing cost can be reduced. Furthermore, since plating of a welding planned portion can be neatly removed by grinding, welding defects can be effectively prevented and stability in a wheel quality can be improved.

According to the second wheel manufacturing method related to the present invention, in addition to the effects of the first wheel manufacturing method, plating of a welding planned portion on an inner circumferential surfaces of the rims of a two-piece wheel can be removed, thereby an two-piece wheel which has plated rims can be fabricated easily and at low cost. In addition, it is made possible to form a smooth surface between a welding planned portion from which plating was removed and a plated area free of level difference, thereby exfoliation of plating at a boundary can be effectively prevented. In addition, since it is possible to change a position of a welding planned portion with respect to the axial direction of a rim by adjusting a position of an abrasive cloth/paper with respect to the axial direction of the inner circumferential surface of the rim, thereby it is made possible to fabricate a two-piece wheel with a disk arranged at an offset position in accordance with a request from a user.

In this second wheel manufacturing method, the use of a grinding belt as the abrasive cloth/paper enables to improve durability thereof, and a grinding operation can be efficiently carried out. In addition, a side edge part of the grinding belt pressed and brought in contact with an inner circumferential surface of a rim is bent during grinding, thereby a welding planned portion from which plating was removed and a plated area can be formed into a smooth surface without having a level difference and exfoliation of plating at the boundary can be effectively prevented.

In addition, setting a rim onto two parallel support rollers with center axes thereof made substantially horizontal and grinding an inner circumferential surface on a bottom part of a rim by an abrasive cloth/paper enable to grind an inner circumferential surface of the rim at substantially the same height even if plating of a different seized rim is removed, and there is no need to adjust a height position of a abrasive cloth/paper for every change of the rim size, it is therefore possible to adopt a grinding device with a simple configuration.

According to the third wheel manufacturing method related to the present invention, in addition to the effects of the first wheel manufacturing method, plating of a welding planned portion of an outer rim can be removed, thereby it is made possible to fabricate three-piece wheels with a plated outer rim easily and at low cost. Furthermore, since a welding planned portion at a superimposed part has a cross-sectional profile protruding outwards, it is made possible to form a smooth surface between a welding planned portion from which plating was removed and a plated area without having a level difference, and as compared to cases of masking or cutting, exfoliation of plating at a boundary area can be effectively prevented.

In the third wheel manufacturing method, when a flap wheel with an abrasive cloth radially arranged is used as the abrasive cloth/paper and a welding planned portion is ground by pressing and bringing the flap wheel in contact with a center part of the welding planned portion in a substantially vertical state, the welding planned portion can be ground while an outer circumferential part of the flap wheel is being bent along a curvature of the welding planned portion; a required width of the welding planned portion can be neatly ground by a single grinding treatment and it is made possible to form a smooth surface between a welding planned portion and a plated part without a level difference while preventing the welding planned portion from being excessively ground, so that exfoliation of plating at the boundary can be effectively prevented further more. In addition, even in the case of a wheel with a different curvature at a welding planned portion, a grinding treatment can be carried out with the same flap wheel and the operability of grinding treatment can be improved.

### BRIEF DESCRIPTION OF THE DRAWINGS

FIG. 1 is a front view of a two-piece wheel;

FIG. 2 is a cross-sectional view taken along a line II-II of FIG. 1;

FIG. 3 is a view explaining a wheel manufacturing process;

FIG. 4(a) and FIG. 4(b) are views explaining a press process and FIG. 4(c) and FIG. 4(d) are views explaining machining process;

FIG. 5 is a view explaining a spinning process;

FIG. 6 is a view explaining a plating removing apparatus;

FIG. 7 shows an operating state of a plating removing apparatus; FIG. 7(a) is a view explaining a state of a rim placed on support rollers; FIG. 7(b) is a view explaining a state of the rim held by holding rollers; and FIG. 7(c) is a view explaining a state immediately before a grinding belt is inserted to the rim;

FIG. 8 is a view explaining an operating condition of a plating removing means; FIG. 8(a) is a view explaining a state of a grinding belt inserted to a rim; FIG. 8(b) is a view explaining a state when a welding planned place is ground by the grinding belt; and FIG. 8(c) is a view explaining that a valve fixing hole is formed by a drill;

FIG. 9 is a view explaining a ground portion by the grinding belt;

FIG. 10 is a cross-sectional view of a three-piece wheel;

FIG. 11 is a view showing an operating condition of a plating removing apparatus; FIG. 11(a) is a view explaining a rim set to a supporting means and FIG. 11(b) is a view explaining a state of the rim held by holding rollers;

FIG. 12 is a view explaining an operating state of a plating removing apparatus; FIG. 12(a) is a view explaining a state immediately before a welding planned portion of the rim is ground by a grinding means and FIG. 12(b) is a view explaining a state of the welding planned portion of the rim ground with the grinding means:

FIG. 13 is a view explaining a grinding operation by abrasive cloth/paper;

FIG. 14 is a view explaining a portion to be ground; and

FIG. 15 is a view explaining a portion to be ground by masking related to a conventional technique.

### DETAILED DESCRIPTION OF THE INVENTION

Referring to the drawings, embodiments of the present invention will be described in detail hereinafter.

First of all, description will be made when the present invention is applied to a manufacturing method of a two-piece wheel 1.

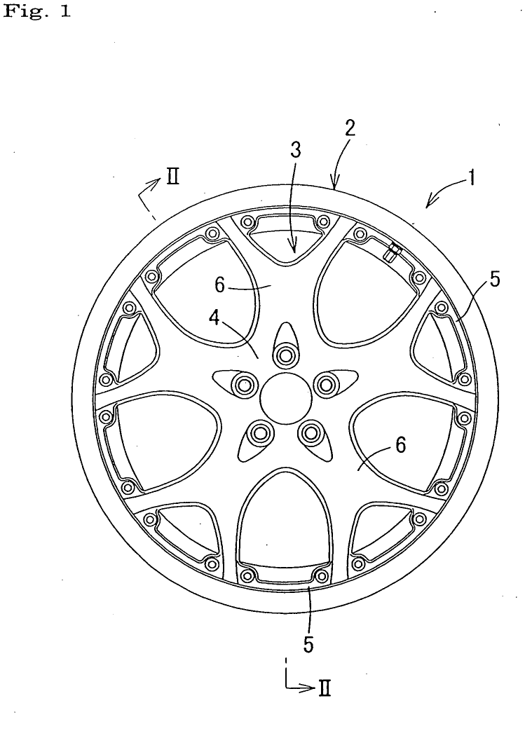

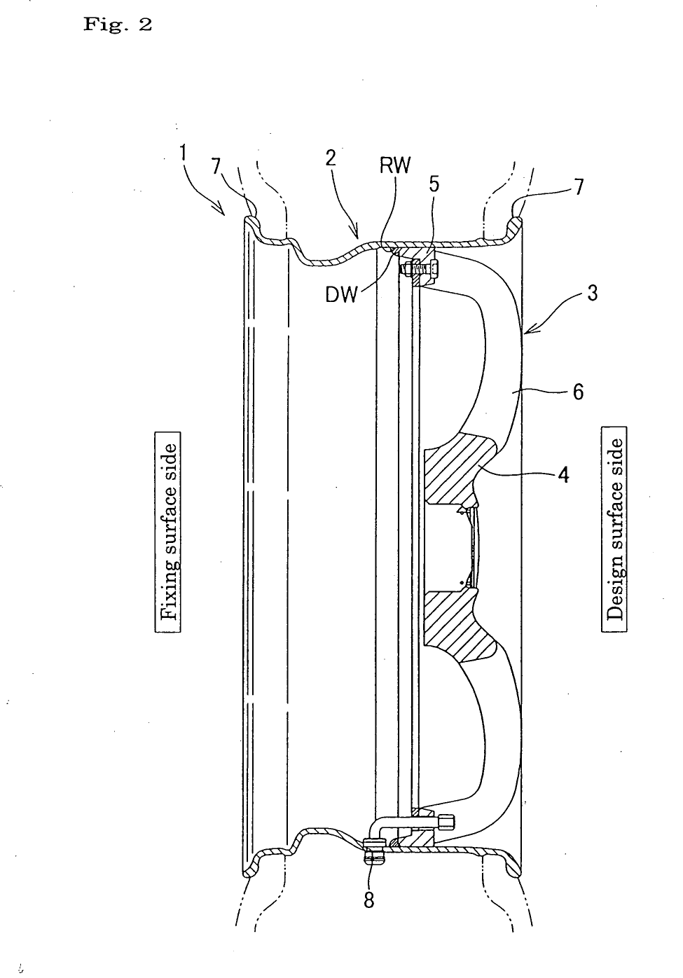

As shown in FIG. 1 and FIG. 2, the two-piece wheel 1 is equipped with a substantially cylindrical rim 2 and a disk 3 fitted into and fixed to a inside the rim 2, in which the two-piece wheel 1 is assembled by welding an outer circumferential part of the disk 3 to be joined to an inner circumferential surface of the rim 2 in a state that the disk 3 is fitted and fixed to the rim 2 by shrink-fitting.

The disk 3 is integrally formed using aluminum alloys and other lightweight metal material by casting, press-forming, and forging or the like, and equipped with a fixing part 4 to a wheel support member (illustration omitted), an annular ring part 5 installed in such a manner as to surround and enclose the fixing part 4 and a spoke part 6 that joins the fixing part 4 to the ring part 5, in which a whole surface thereof is subjected to a chromium-plating treatment. The plating treatment is carried out by a widely known method to immerse the rim 2 in plating liquid, and plating of a welding planned portion DW of the disk 3 with respect to the rim 2 is removed by masking or grinding.

The rim 2 is composed with metal material with superb stretchability such as aluminum alloys, and a whole surface thereof is subjected to a treatment such as chromium plating. The plating treatment is carried out by a widely known method to immerse the rim 2 in plating liquid and plating of a welding planned portion RW of the rim 2 with respect to the disk 3 is removed in grinding by a plating removing apparatus 20 discussed below.

At an end part on a design surface side and an end part on a fixing surface side of the rim 2, flange parts 7 are formed with a wall thicker than other parts by increasing a wall thickness. Because the flange part 7 is configured to be thick by increasing the wall thickness in this way, when the rim 2 is subjected to a plating treatment, plating liquid or the like is securely prevented from remaining inside the flange part 7 and corrosion of the flange part 7 caused by the remaining plating liquid can be prevented. In addition, because the flange part 7 is configured to have a thick wall, strength and rigidity of the wheel 1 can be sufficiently secured during rotation or the like.

Next description will be made on a manufacturing method of the wheel 1.

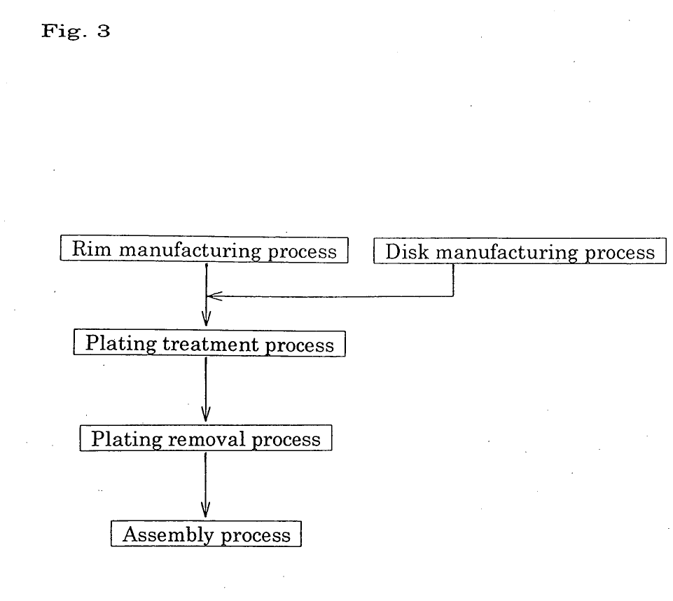

The manufacturing method of this wheel 1 is composed of, as shown in FIG. 3, a rim manufacturing process for manufacturing the rim 2, a disk manufacturing process for manufacturing the disk 3, a plating treatment process for providing chromium plating to the rim 2 and the disk 3, a plating removing process for removing plating of welding planned portions RW and DW between the rim 2 and the disk 3, and an assembly process for assembling the wheel 1 from the rim 2 and the disk 3. Because the present invention is characterized by a configuration of easily and neatly removing plating of the welding planned portion RW on the inner circumferential surface of a rim 2, processes other than the plating removing process of the rim 2 will be briefly explained.

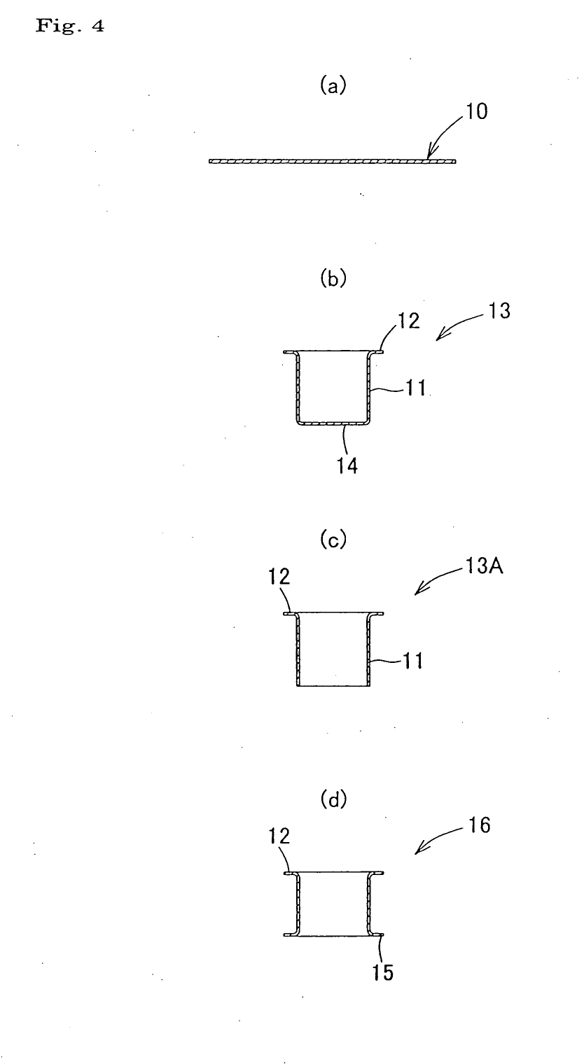

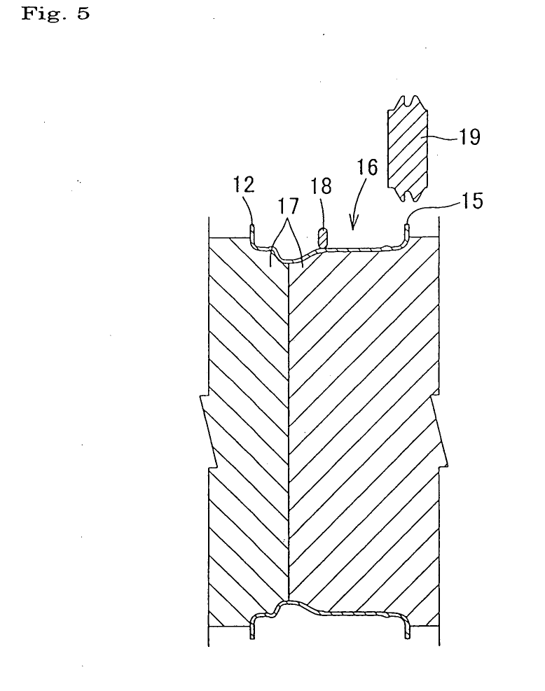

In the rim manufacturing process, a disk-form rolled metal plate 10 with superb stretchability such as aluminum alloy is press-formed as shown in FIG. 4(a), so as to fabricate a primary forming 13 having a cylindrical tubular part 11 with a bottom 14 and a flange part 12 that extends outwards from an end part of an opening side of the tubular part 11 as shown in FIG. 4(b), after which a primary forming 13A is fabricated by removing the bottom part 14 of the primary forming 13 by punching processing or the like as shown in FIG. 4(c), and a flange part 15 is formed next by press-forming an opening end part of the primary forming 13A from which the bottom 14 was removed, so as to fabricate a secondary forming 16 with flange parts 12 and 15 formed on both ends of the tubular part 11 as shown in FIG. 4(d). The manufacturing method of the secondary forming 16 can be provided in such a manner that a slender rolled metal sheet with outstanding stretchability such as aluminum alloy is rolled in a cylindrical form and both end parts are welded to fabricate a tubular member, in which both end parts of this tubular member is subjected to press-forming to form flange parts.

Then, as shown in FIG. 5, the secondary forming 16 is externally fitted to be fixed to a mandrel 17, and while the secondary forming 16 is being rotated together with the mandrel 17, the secondary forming 16 is subjected to spinning processing using rollers 18 and 19 so that the rim 2 of a cross-sectional form as shown in FIG. 2 is obtained.

On the other hand, in the disk manufacturing process, the disk 3 is fabricated by forming metal material into a disk form by widely known manufacturing methods such as casting, press-forming, and forging or the like using aluminum alloys and other lightweight metal material.

In the plating treatment process, the disk 3 and the rim 2 are subjected to degreasing, water rinsing, acid treatment, water rinsing, copper plating, water rinsing, nickel plating, water rinsing, and chromium plating successively so as to form a chromium plating layer on a whole surface with two layers of copper and nickel used as substrate layers on the disk 3 and the rim 2.

In the plating removal process, the welding planned portions RW and DW on the rim 2 and the disk 3 are ground to remove the chromium plating on the welding planned portions.

When plating of the welding plating portion DW on the disk 3 is ground and removed, the disk 3 is set to a rotary table, and the welding planned portion on an outer circumferential part of the disk 3 is subjected to a grinding treatment by a portable grinder while rotating the disk 3 together with the rotary table, thereby the chromium plating of the welding planned portion is removed. However, with respect to the disk 3, it is possible to provide a configuration to prevent a formation of plating on the welding planed portion by carrying out a plating treatment with a masking tape affixed to the welding planned portion at the time of plating, so as to omit the plating removal process.

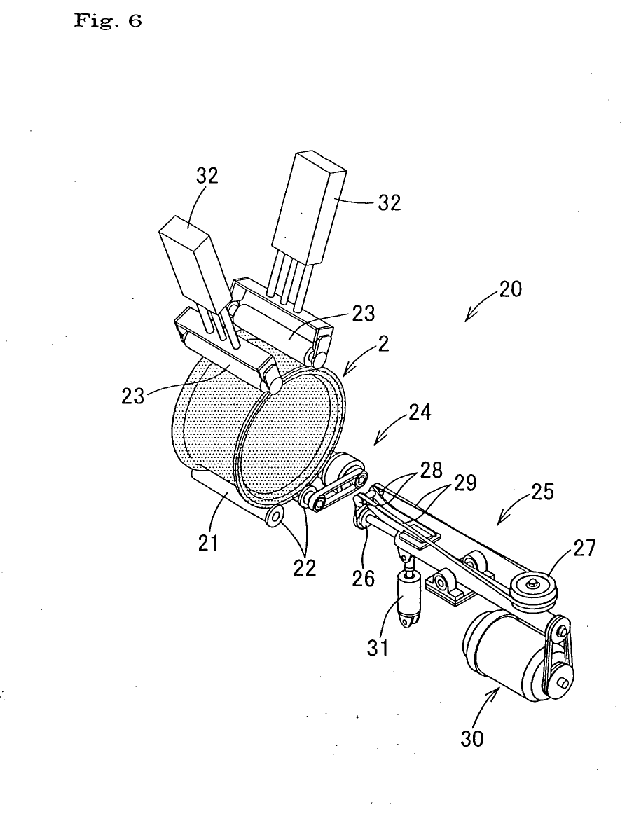

When plating of the welding planned portion RW of the rim 2 is ground and removed, a plating removing apparatus with a configuration as shown in FIG. 6 is used to remove plating of the welding planned portion RW by grinding the plating of the welding planned portion RW using an abrasive cloth/paper composed with a grinding belt 29.

The plating removing apparatus 20 is equipped with a pair of support rollers 21 horizontally arranged by setting center axes thereof in parallel at an interval smaller than an outer diameter of the rim, a positioning member 22 for positioning the rim 2 supported on the support rollers 21 with a center axis thereof made substantially horizontal in the axial direction of the support roller 21, a pair of holding rollers 23 arranged substantially in parallel to the support roller 21 above the support roller 21, and actuator 32 for holding the rim 2 between the support roller 21 and the holding roller 23 by pressing the rim 2 positioned and held on the support roller 21 from an upper side by the holding roller 23, a rotation drive means 24 for rotating and driving the rim 2 held between the support rollers 21 and holding rollers 23, and a grinding means 25 that extends to an inside of the rim 2 for grinding the welding planned portion RW of the rim 2 with respect to the disk 3 so as to remove plating of the welding planned portion RW.

The grinding means 25 is configured to have a drive pulley 26 supported rotatably around a center axis thereof substantially in parallel to the center axis of support rollers 21, an idler pulley 27 arranged with a center axis thereof made substantially vertical, a grinding belt 29 stretched between both the drive pulley 26 and the idler pulley 27 with a direction thereof changed at a halfway part by guide rolls 28, a drive means 30 for grinding that rotates and drives the drive pulley 26, and a pressurizing cylinder 31 for pressing the grinding belt 29 stretched to the drive pulley 26 against a welding planned portion on the rim 2, so as to grind a bottom part of an inner circumferential surface of a rim by the grinding means 25.

In this plating removing apparatus 20, a peripheral velocity of the grinding belt 29 with respect to the welding planned portion RW is set to 150 to 600 m/min, the pressurizing force with respect to the rim 2 is set to be 0.5 kN to 1.5 kN, and a rotating speed of the rim 2 is set to be 5 to 100 rpm so that a grinding treatment can be implemented for the welding planned portion RW during a single rotation of the rim 2. However, it is also possible to provide a configuration to complete the grinding treatment during multiple rotations of the rim 2. A width of the grinding belt 29 is set to be equal to or slightly larger than that of the welding planned portion RW so that plating of the welding planned portion RW can be ground by a single grinding treatment. However, grinding can be divided into multiple steps of grinding in the axial direction.

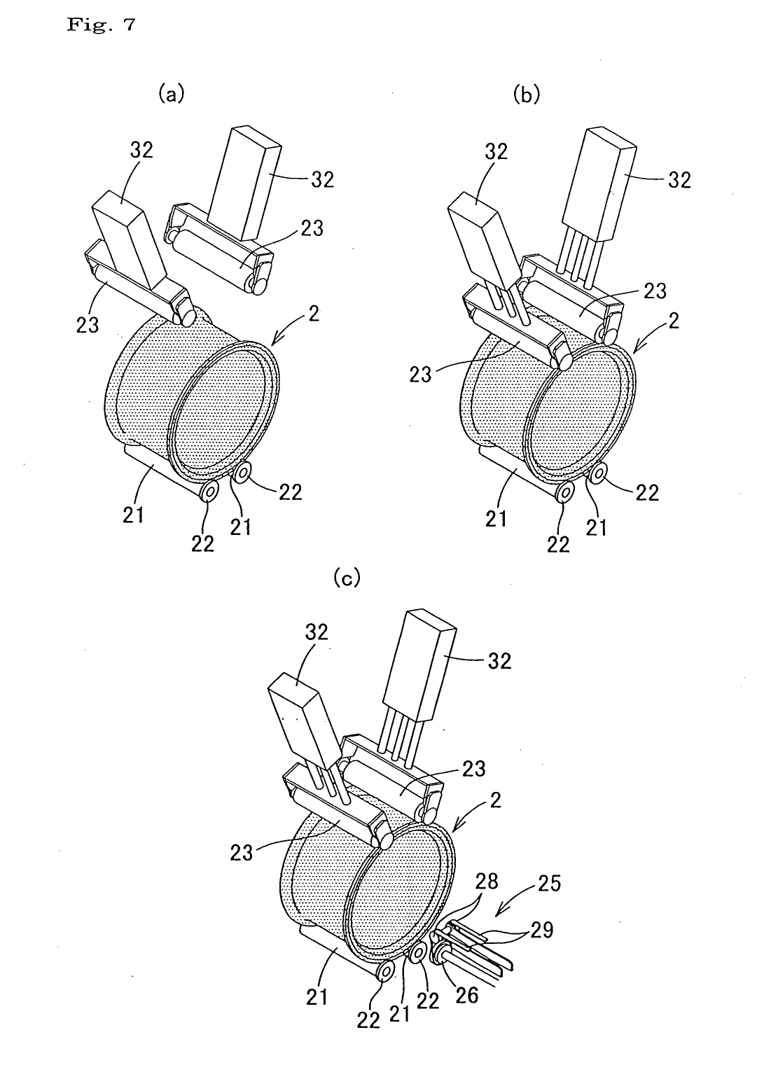

When this plating removing apparatus 20 is used to grind a welding planned portion on an inner circumferential surface of the rim 2, the rim 2 is placed on the support rollers 21 with a center axis thereof directed in the horizontal direction first, and then an end of the rim 2 is brought in contact with the positioning member 22 to position and set the rim 2 in the horizontal direction on the support rollers 21 as shown in FIG. 7(a) so that the holding rollers 23 are protruded downward by the actuator 32 to hold the rim 2 between the support roller 21 and the holding roller 23 as shown in FIG. 7(b).

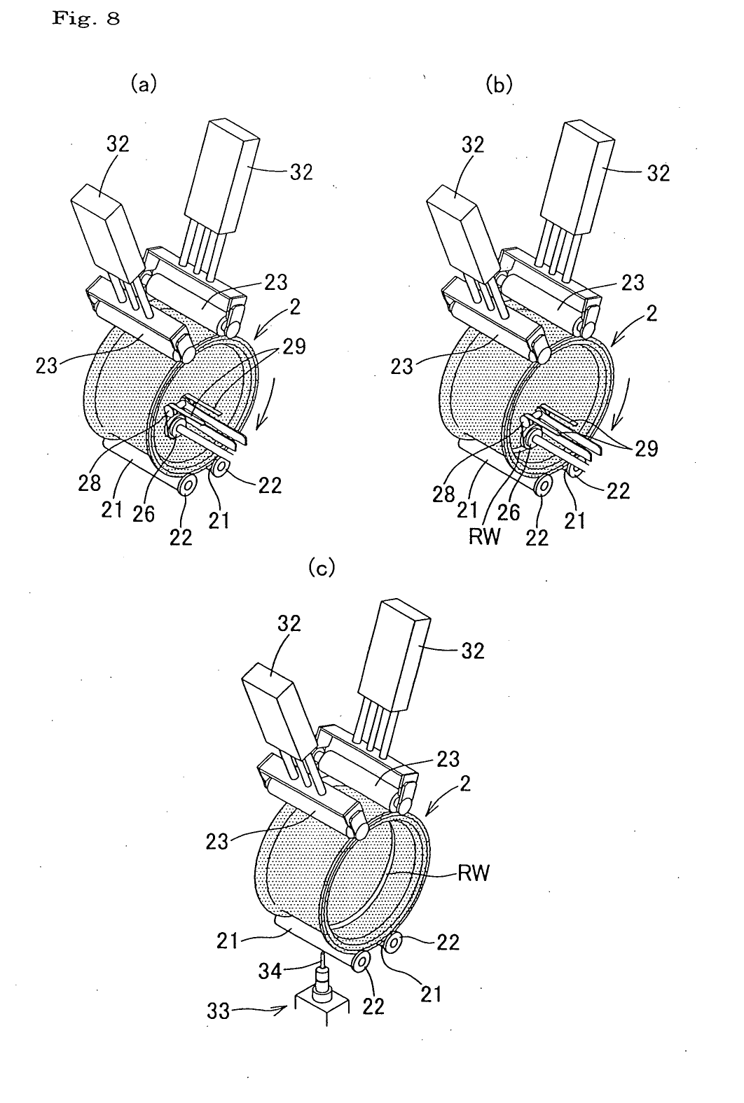

Then, the grinding means 25 is moved from a retracted position shown in FIG. 6 and FIG. 7(c) to an advancing position as shown in FIG. 8(a), in which the support roller 21 is rotated by the rotation drive means 24 to rotate the rim 2 at low speed with a rotating speed of, for example, 10 rpm, while allowing the grinding belt 29 to orbit, and pressing and bringing the grinding belt 29 applied to the drive pulley 26 to be in contact with the welding planned portion RW on a bottom part of the inner circumferential surface of the rim 2 rotating at low speed, so that the welding planned portion RW of the rim 2 rotating at low speed is successively ground, and plating in the welding planned portion RW is successively removed as shown in FIG. 8(b).

After plating of the welding planned portion RW is thus removed throughout a whole circumference by a single rotation of the rim 2, the grinding belt 29 is separated from the inner circumferential surface of the rim 2, and a rotation of the rim 2 by the drive means 30 for grinding is stopped, in which a drill 34 is raised to form a valve fixing hole (refer to FIG. 2) while the drill 34 is being rotated by the drill drive means 33 as shown in FIG. 8(c). However, it is possible to provide a configuration to remove plating of the welding planned portion RW after forming the valve fixing hole 8 by the drill 34.

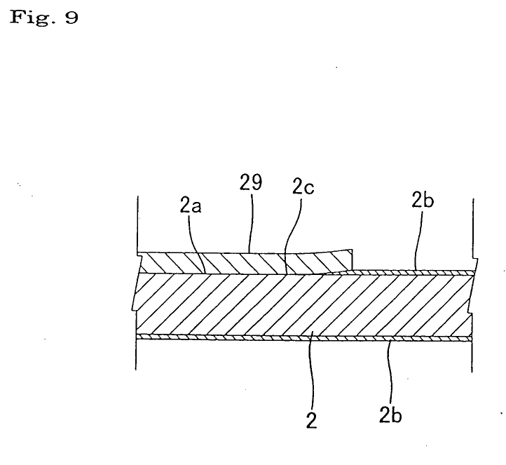

If the plating removing apparatus 20 is used as stated above, a side edge of the grinding belt 29 is subtly bent as shown in FIG. 9 while the welding planned portion RW is ground by the grinding belt 29, a base material surface 2a of the welding planned portion RW in which plating was removed and a surface of the plated area 2b is smoothly connected without forming a level difference at a boundary 2c between the base material surface 2a and the plate area 2b, thereby effective preventing nonconformity including exfoliation of the plated area 2b from the boundary 2c during welding or others.

In addition, removal of plating of the welding planned portion RW by grinding enables to neatly remove plating of the welding planned portion RW in a substantially complete state, and welding defects of the disk 3 with respect to the rim 2 can be securely prevented. In addition, since it is possible to plate a whole surface of the rim 2 without affixing a masking tape, a labor cost used for a plating treatment can be minimized and a manufacturing cost of the wheel 1 can be reduced.

Furthermore, a bottom part of an inner circumferential surface of the rim 2 is ground in a state that the rim is held by the support rollers 21, even when a plated area of the rim 2 with a different size is removed, a grinding portion in the inner circumferential surfaces of rims 2 is substantially the same without causing an adjustment of a relationship in height between the grinding means 25 and the rim 2, thereby a plating removal operability can be remarkably improved.

Because grinding can be carried out by the use of the grinding belt 25, it is made possible to increase a durability of the grinding belt 29 as a grinding tool while the drive pulley 26 inserted inside the rim 2 is made compact, and a grinding operation can be efficiently carried out.

It is also possible to provide a position adjusting means that adjusts a position to be ground by the grinding means 25 in the axial direction of the rim 2, and in such event, an axial position of the welding planned portion RW can be optionally adjusted, thereby a wheel can be fabricated by adjusting a mounting position of the disk 3 with respect to the axial direction of the rim 2 in accordance with a request from a user. In addition, if the plating of the welding planned portion RW can be removed by grinding, plating can be removed by a plating removing apparatus with a configuration other than that of the plating removing apparatus 20.

Next in the assembly process, the rim 2 is heated by an induction heating apparatus, and an inside diameter of the rim 2 is expanded by thermal expansion, in which the disk 3 is inserted into a setting position inside the rim 2 in the axial direction and a temperature of the rim 2 is lowered by air cooling, so that the disk 3 is fitted and fixed to an inside of the rim 2 by shrink fitting. Then, TIG welding or MIG welding is carried out to successively weld and join the welding planned portions DW and RW of the disk 3 and the rim 2, and to obtain a two-piece wheel 1 as shown in FIG. 1 and FIG. 2.

In this manufacturing method of the wheel 1, as described above, the welding planned portion RW on an inner circumferential surface of the rim can be easily and neatly ground with accuracy by grinding, enabling a low manufacturing cost of the two-piece wheel 1 with the rim 2 plated by chromium.

Next discussion is made on an embodiment in which the present invention is applied to a fabrication method of a three-piece type wheel 51.

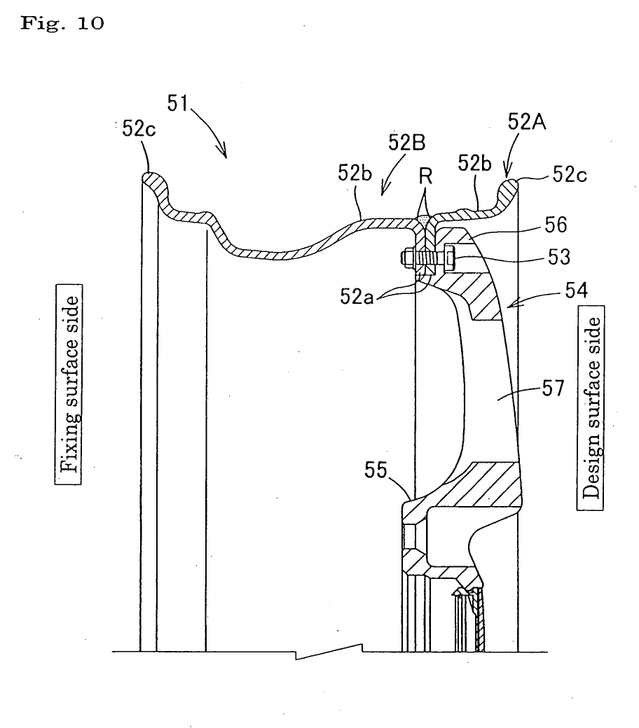

As shown in FIG. 10, the three-piece wheel 51 has a substantially cylindrical outer rim 52A and inner rim 52B which have an annular superimposed part 52a extending to an inner side on one end part, and a disk 54 fixed to the superimposed part 52a of both of the outer rim 52A and the inner rim 52B with a bolt not shown.

The disk 54 which is integrally formed using aluminum alloys and other lightweight metal material by casting, press-forming, and forging or the like is equipped with a fixing part 55 to a wheel support member (omitted from drawings), an annular ring part 56 installed in such a manner as to surround and enclose the fixing part 55 and a spoke part 57 that joins the fixing part 55 to the ring part 56, in which a whole surface thereof is subjected to a chromium-plating treatment. The plating treatment is carried out by a widely known method to immerse the disk 54 in plating liquid. However, the disk 4 is not necessarily provided with the plating treatment and may be provided with coating.

Both the outer rim 52A and the inner rim 52B are composed with metal material with superb stretchability such as aluminum alloys and others. A whole surface of the outer rim 52A is subjected to a plating treatment such as chromium plating and other plating by a widely known method to immerse the outer rim 52A in plating liquid in order to improve design features thereof. The inner rim 52B may be provided with a chromium plating treatment in the same manner with the outer rim 52A, but an alumite treatment which can be implemented at low cost is provided for the inner rim 52B which has little effect on the design features.

In the outer rim 52A and the inner rim 52B, a substantially cylindrical body part 52b linked to the superimposed part 52a is formed, and flange parts 52c are formed with a wall thickness increased to have wall thicker than other parts at the end part on the design surface side of the outer rim 52A and the end part on the fixing surface side of the inner rim 52B, respectively. The flange parts 52c are thus configured to be thick by increasing the wall thickness, thereby when the outer rim 52A is subjected to a plating treatment, plating liquid or the like is securely prevented from remaining inside the flange parts 52c and corrosion of the flange parts 52c caused by the remaining plating liquid can be prevented. In addition, because the wall thickness configured on the flange part 52c of both the outer rim 52A and the inner rim 52B is sufficiently secure, strength and rigidity of a wheel 51 can be satisfactorily secured during rotation or the like.

On an outer circumferential surface of a curved part linked from the superimposed part 52a to the body part 52b, the welding planned portions R are respectively formed with plating and oxide film removed to expose the base material. Plating of the welding planned portion R on the outer rim 52A is removed by a plating removing apparatus 60 discussed later to expose the base material while oxide film of the welding planned portion R of the inner rim 52B is removed by a wire brush or the like to expose the base material. However, when a plating treatment is provided for the inner rim 52B, plating of the welding planned portion R is removed by the plating removing apparatus 60 later discussed in the same manner as the outer rim 52A.

When the wheel 51 is assembled, the superimposed parts 52a of both the outer rim 52A and the inner rim 52B are superimposed, fixing this superimposed part 52a to an outer circumferential part of the disk 54 with the bolt 53 and integrating both of the outer rim 52A and the inner rim 52B to the disk 54 into one, and welding both of the welding planned portions R from the outer circumferential side to assemble the wheel 51.

Next discussion will be made on a manufacturing method of the wheel 51.

This manufacturing method of the wheel 51 has a different content for the operation in each process of the embodiment described above but has similar processing steps as shown in FIG. 3. Specifically, a configuration of the processing steps includes a rim manufacturing process for manufacturing the outer rim 52A and the inner rim 52B, a disk manufacturing process for manufacturing the disk 54, a plating process for providing a chromium plating treatment to the outer rim 52A and the disk 54, a plating removing process for removing plating of the welding planned portion R of the outer rim 52A with respect to the inner rim 52B, and an assembly process for assembling the wheel 51 from both of the outer rim 52A and the inner rim 52B and the disk 54. Because the present invention is characterized by a configuration to easily and neatly remove plating of the welding planned portion R of the outer rim 52A, processes other than the plating removing process of the outer rim 52A will be briefly described.

Now the rim manufacturing process will be described. In a press process similar to the above-mentioned embodiment, as shown in FIG. 4(a), a disk-form rolled metal plate 10 with superb stretchability such as aluminum alloy is press-formed to fabricate a primary forming 13 having a cylindrical tubular part 11 with a bottom 14 and a flange part 12 externally extending from an end part on an opening side of the tubular part 11. However, when the outer rim 52A is manufactured, an axial length of the cylindrical part 11 is set to fit in an axial length of the outer rim 52A, and when the inner rim 52B is manufactured, it is set to fit in an axial length of the inner rim 52B. Then, a primary forming 13A is fabricated by removing a bottom part 14 of the primary forming 13 by punching processing or the like. Whole of the bottom part 14 of the primary forming 13 may be cut off, but a flange part that extending to a center part side may be formed by cutting off the center part only so that the flange part is used for a superimposed part 52a. Then, the primary forming 13A is externally fitted and fixed to a mandrel, rotating the primary forming 13A together with the mandrel, carrying out spinning processing to the primary forming 13A by using rollers, thereby the outer rim 52A and the inner rim 52B of a cross-sectional form as shown in FIG. 10 are obtained.

In the disk manufacturing process, disk 54 is fabricated by forming metal material into a disk form by a widely known manufacturing method such as casting, press-forming, and forging using aluminum alloys and other lightweight metal material.

In the plating process, the disk 54 and the outer rim 52A are subjected to degreasing, water rinsing, acid treatment, water rinsing, copper plating, water rinsing, nickel plating, water rinsing, and chromium plating successively so as to form a chromium plating layer on a whole surface with two layers of copper and nickel used as a substrate layer on the disk 54 and the outer rim 52A. The chromium plating can also be provided for the inner rim 52B in the same manner with the outer rim 52A, but an alumite treatment feasible at an inexpensive price is provided for the inner rim 52B which has little affects on the design features.

In the plating removal process, plating of the welding planned portions R on the outer rim 52A is removed by an abrasive cloth/paper 61 using the plating removing apparatus 60 of the following configuration and plating at the welding planned portions is ground and removed.

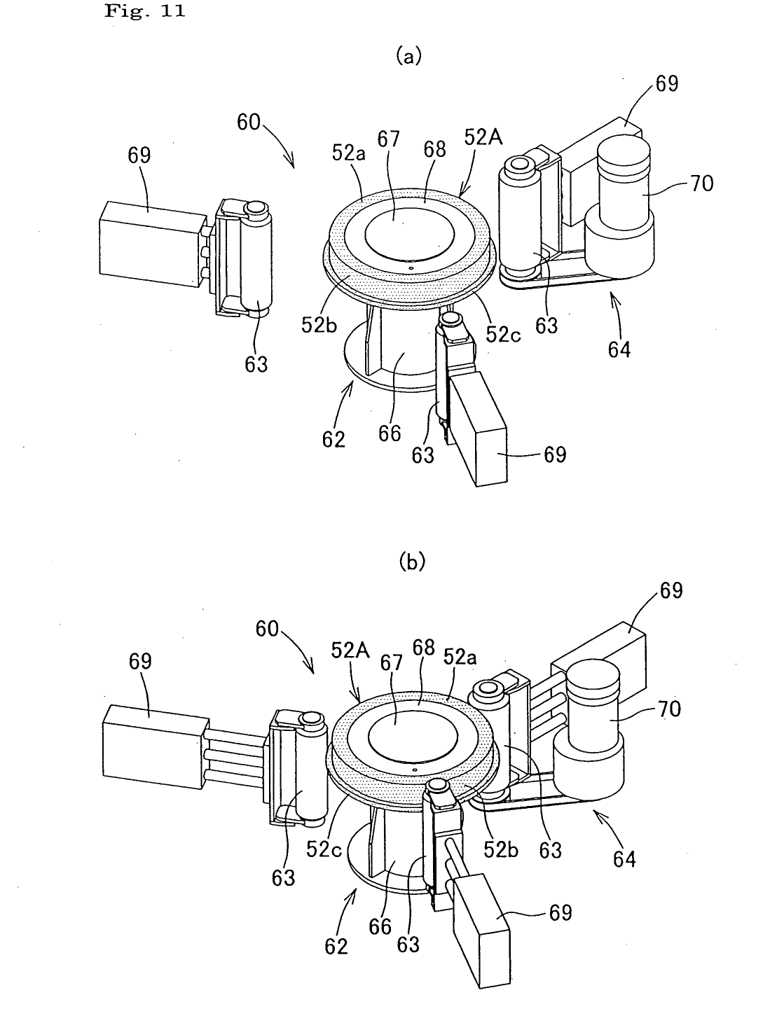

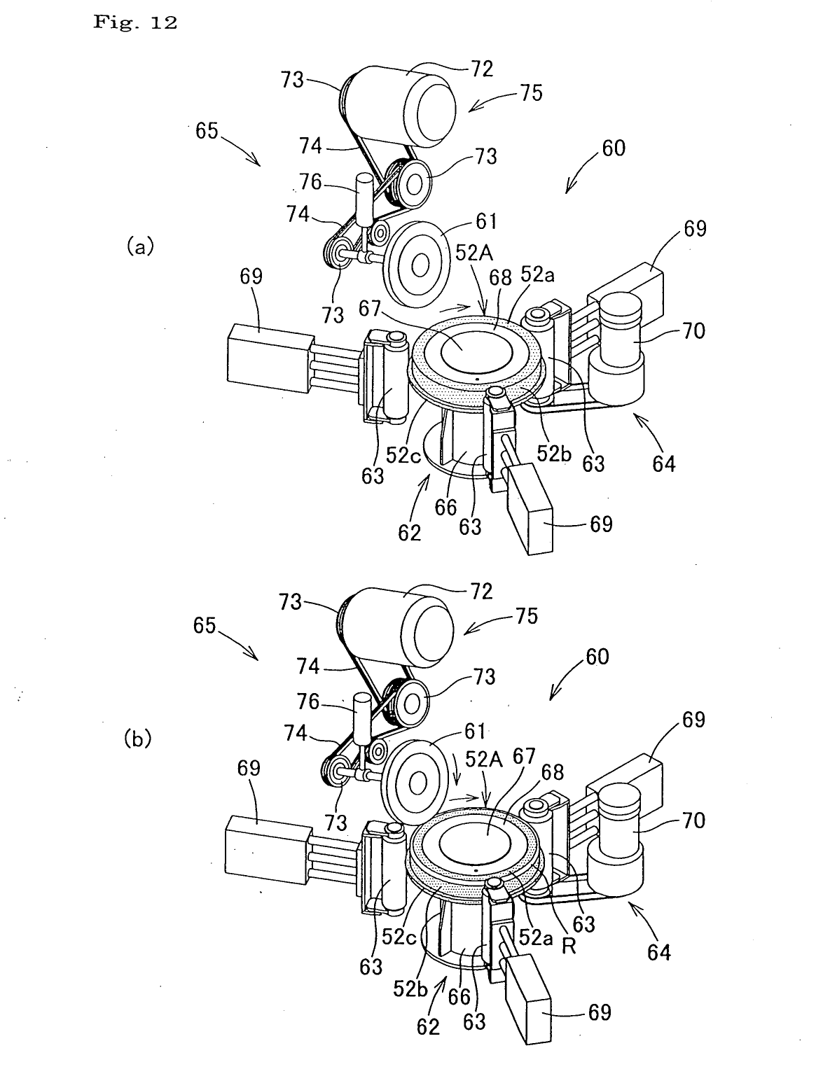

As shown in FIG. 11 and FIG. 12, the plating removing apparatus 60 is equipped with a support means 62 that rotatably supports the outer rim 52A with a center axis held substantially vertical, a rotation drive means 64 that rotates and drives the outer rim 52A supported to the support means 62 held by three holding rollers 63 from the outer circumferential side, and a grinding means 65 that removes plating of the relevant welding planned portion R by grinding the welding planned portion R on the outer circumferential surface of the curved part of the outer rim 52A with abrasive cloth/paper 61.

The support means 62 is equipped with a rotary plate 67 which is rotatably supported by a support tube 66 and a jig plate 68 which is removably and externally fitted and fixed to the rotary plate 67, in which it is configured to set the outer rim 52A to the jig plate 68 with a center axis of the rim 52A made substantially vertical to the jig plate 68 and the superimposed part 52a side made to be in an upper side, so that the body part 52b extends downwards from the superimposed part 52a. In addition, it is configured to support the outer rim 52A of various sizes by the support means 62 by replacing the jig plate 68 with that of a different sized outside diameter.

The rotation drive means 64 is primarily composed of three holding rollers 63 rotatably installed with a center axes thereof made in the vertical direction at specified intervals in the circumferential direction on an outside of the outer rim 52A supported by the support means 62, an air cylinder 69 which pressurizes and brings the holding rollers 63 in contact with the flange part 52c of the outer rim 52A, and an electrically-driven motor 70, in which the rotation drive means 64 for rotating and driving one holding roller 63 is configured to rotate the outer rim 52A at low speed by rotating and driving one holding roller 63 with the rotation drive means 64 in a state that the outer rim 52A is held by the three holding rollers 63.

The grinding means 65 is equipped with a drive means 75 which has an electrically-operated motor 72, a plurality of pulleys 73, and a belt 74 stretched between the pulleys 73, and an abrasive cloth/paper 61 including a flap wheel rotated and driven by the drive means 75. As the abrasive cloth/paper 61, it is possible to use those other than the flap wheel. In particular, it is preferable to use the abrasive cloth/paper 61 which can deform an outer circumferential surface thereof along a curved surface of the welding planned portion R, so that plating of the welding planned portion R can be neatly ground and removed by a single operation. In addition, this grinding means 65 is configured to be capable of adjusting a position thereof in such a manner that the abrasive cloth/paper 61 is pressurized and brought in contact substantially vertical to the welding planned portion R by an elevating means and a horizontal moving means not shown.

In this plating removing apparatus 60, a rotating speed of the outer rim 52A can be optionally set, but in order to sufficiently secure the processing capacity and surface properties of a grinding surface, the rotating speed of the outer rim 52A is set to be, for example, 5-100 rpm, and a rotating speed of the abrasive cloth/paper 61 is set to be 1500-3000 rpm, and the pressurizing contact force of the abrasive cloth/paper 61 with respect to the outer rim 52A is set to be 0.5 kN-1.5 kN so as to provide a configuration that the welding planned portion R can be ground during a single rotation of the outer rim 52A. However, it is also possible to provide a configuration to complete the grinding treatment during multiple rotations of the rim 2 or to divide the grinding treatment into multiple treatments in the axial direction. A width of the abrasive cloth/paper 61 is preferably set to be slightly larger than that of the welding planned portion R so that plating of the welding planned portion R can be ground and removed by a single grinding treatment.

When plating is removed by the use of this plating removing apparatus 60, as shown in FIG. 11(a), the jig plate 68 suitable for an inside diameter size of the outer rim 52A subjected to a grinding treatment is set to the rotary plate 67, and then the outer rim 52A is set with a center axis thereof made substantially vertical to the jig plate 68, and the superimposed part 52a side made to be in an upper side in such a manner that the body part 52b extends downwards from the superimposed part 52a.

Then, as shown in FIG. 11(b), the holding rollers 63 are allowed to advance by the air cylinder 69 and an outer circumferential part of the flange part 52c set to the support means 62 is held by the three holding rollers 63.

In this way, in a state that the outer rim 52A is held by three of the holding rollers 63 of the rotation drive means 64, one of the holding rollers 63 is rotated and driven by the rotation drive means 64, thereby the outer rim 52A is rotated and driven at low speed of, for example, 50 rpm.

On the other hand, as shown in FIG. 12(a), a vertical directional position and a longitudinal directional position of the abrasive means 65 are adjusted in such a manner that the abrasive cloth/paper 61 faces the welding planned portion R of the outer rim 52A with a subtle clearance provided in accordance with the size of the outer rim 52A.

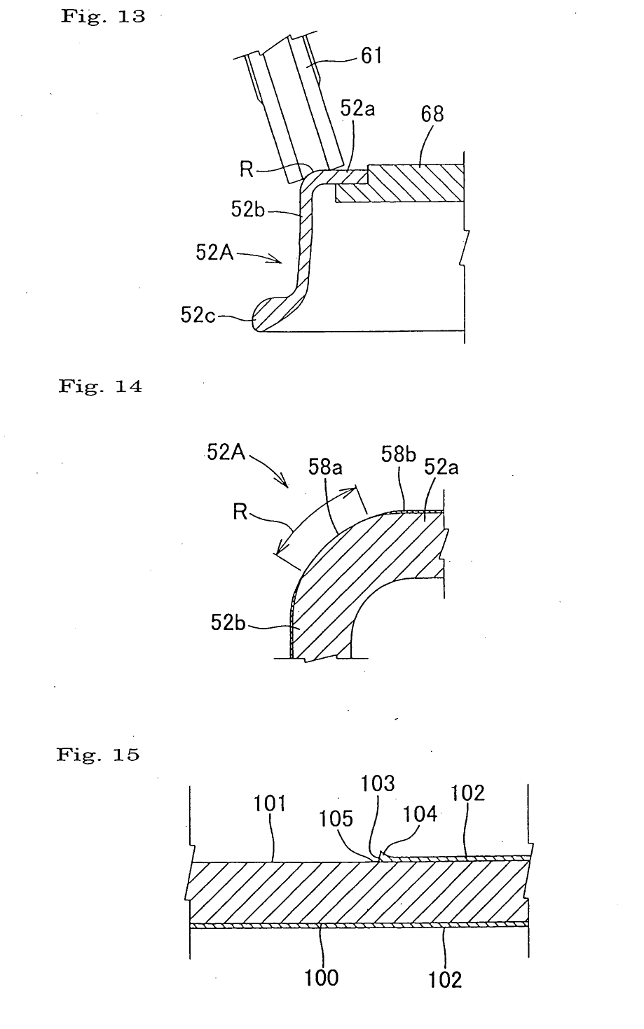

And as shown in FIG. 12(b), while the abrasive cloth/paper 61 is rotated by the electrically-operated motor 72, the abrasive cloth/paper 61 is pressed and brought in contact with the welding planned portion R of the outer rim 52A by the pressurizing cylinder 76, so as to grind plating of the welding planned portion R. In such event, the abrasive cloth/paper 61 is pressed and brought in contact with a center part in a substantially vertical state, and an outer circumferential surface of the abrasive cloth/paper 61 is deformed in such a manner that a center part thereof in the thickness direction is slightly dented along a curved surface of the welding planned portion R as shown in FIG. 13, thereby the wide welding planned portion R is ground at a single time. In addition, in the welding planned portion R and its vicinity where a grinding treatment was carried out, as shown in FIG. 14, the base material area 58a and the plated area 58b of the welding planned portion R are smoothly linked and no level difference is formed at a boundary between the base material area 58a and the plated area 58b, therefore, exfoliation of the plated area 58b can be effectively prevented.

In this way, while the outer rim 52A is allowed to make a single rotation by the rotation drive means 64, and when grinding of the welding planned portion R is completed, pressurization by the pressurizing cylinder 76 is stopped to separate the abrasive cloth/paper 61 from the outer rim 52A, while a rotation of the abrasive cloth/paper 61 is stopped to reverse the holding roller 63 and remove the ground outer rim 52A which is subjected a grinding treatment from the jig plate 68, after which a new outer rim 52A is set to the jig plate 68, and plating of the welding planned portion R is ground and removed again in the same manner as stated above. In the present embodiment, while the outer rim 52A is being turned around to make a single rotation, the welding planned portion R is successively subjected to a grinding treatment, but the grinding treatment can be carried out during several rotations or the welding planned portion R may be divided into multiple portions in the width direction for the successive grinding.

In the assembly process, the superimposed portions 52a of both of the outer rim 52A and the inner rim 52B are superimposed while an outer circumferential part of the disk 54 is fixed to this superimposed part 52a with the bolt 53 to integrate both of the outer rim 52A and the inner rim 52B to the disk 54 into one, after which the welding planned portions R of both of the outer rim 52A and the inner rim 52B are successively welded and joined from an outer circumferential side of the inner rim 52B by TIG welding or MIG welding, and a three-piece wheel 51 as shown in FIG. 10 is obtained.

When plating is provided for the inner rim 52B, as is the case of the outer rim 52A, using the plating removing apparatus 60, the welding planned portion R of an outer circumferential surface of the curved part linked from the superimposed part 52a to the cylindrical part 52b of the inner rim 52B can be ground.

1-4. (canceled)

5. A method for manufacturing three-piece type wheels having an inner rim, an outer rim, and a disk, comprising steps of:
providing a chromium plating treatment to the outer rim as a wheel component member;
grinding a welding planned portion on an outer circumferential surface of a curved portion linked from a superimposed parts of rims to a cylindrical body part in the outer rim by an abrasive cloth/paper to remove plating of the welding planned portion;
assembling both of the rims by superimposing the superimposed parts while superimposing an outer circumferential parts of the disk to the superimposed parts;
fixing the disk to the superimposed parts with bolts; and
welding to join the welding planned portions of both of the rims from an outside.

6. The method for manufacturing wheels according to claim 5, wherein a flap wheel with an abrasive cloth arranged radially is used as the abrasive cloth/paper, and the flap wheel is pressed and brought into contact with a center part of the welding planned portion in a substantially vertical state so as to grind the welding planed planned portion.
